(19) United States
(12) Patent Application Publication
(10) Pub. No.: US 2012/0268375 A1
(43) Pub. Date: Oct. 25, 2012

(54) MOUSE WHEEL ASSEMBLY

(75) Inventors: Chih Hung LU, Hsin-Chu (TW); Wei Chung WANG, Hsin-Chu (TW)

(73) Assignee: PIXART IMAGING INC., Hsin-Chu (TW)

(21) Appl. No.: 13/544,530

(22) Filed: Jul. 9, 2012

Related U.S. Application Data
(62) Division of application No. 12/723,555, filed on Mar. 12, 2010.

(30) Foreign Application Priority Data
Apr. 20, 2009 (TW) 098206542

(51) Int. Cl. G06F 3/033

(52) U.S. Cl. 345/163

(57) ABSTRACT

A mouse wheel assembly is provided according to the present invention. The mouse wheel assembly includes a member and an optical module. The member has a pattern formed thereon. The optical module is adapted to illuminate the pattern on the member, capture an image of the pattern as a result of the illumination and recognize a feature change of the image of the pattern to obtain the change direction and change speed of the member.

### CROSS REFERENCE TO RELATED APPLICATION

This application is a divisional of U.S. application Ser. No. 12/723,555, filed Mar. 12, 2010 and claims the priority benefit of Taiwan Patent Application Serial Number 098206542 filed Apr. 20, 2009, the full disclosure of which is incorporated herein by reference.

### BACKGROUND OF THE INVENTION

1. Field of the Invention

The invention relates to an input apparatus, and more particularly, to an optical mouse wheel assembly.

2. Description of the Related Art

Referring to FIG. 1, a conventional mouse apparatus 9 includes a body 90 having at least one function button 91 and a wheel 92. The function button 91 is configured for a user to click or double-click on an icon or show a pull-down menu. The wheel 92 is configured for a user to, for example, scroll the screen of a computer. The body 90 of the mouse apparatus 9 is commonly formed by combining a base with a dome cover.

Referring to FIG. 2, a conventional mechanical mouse wheel structure includes a wheel 92 longitudinally positioned in the body 90 and a mechanical encoder 93 positioned in the body 90. The wheel 92 is pivotally positioned near the front end of the body 90. A user can rotate the wheel 92 to drive the mechanical encoder 93. When the mechanical encoder 93 is driven, it will generate a signal to control the scrolling of the screen.

Unfortunately, the above mechanical mouse apparatus 92 usually achieves a poor resolution performance. The resolution of the mechanical mouse apparatus 92 can only be enhanced by replacing the mechanical encoder 93 with one that is of high resolution. However, a high-resolution mechanical encoder is always expensive.

Accordingly, there exists a need to provide an optical mouse wheel assembly to solve the above problems.

### SUMMARY OF THE INVENTION

The present invention provides a mouse wheel assembly, the image sensor of which can continuously capture a plurality of images of a pattern and recognize the feature change of the images thereby obtaining the operation direction and rotation speed of a mouse wheel.

The present invention provides a mouse wheel assembly that can obtain the operation direction and rotation speed of a mouse wheel by analyzing optical characteristics without the need of high-resolution mechanical encoders. Therefore, the production cost of the mouse wheel assembly of the present invention is relatively low.

The present invention provides a mouse wheel assembly. The mouse wheel assembly includes a first wheel, a second wheel, a belt, a light source, an image sensor and a processing unit. The belt has a pattern formed thereon. The belt is looped over the first wheel and the wheel surface of the second wheel, wherein the second wheel is driven to rotate by the belt when the first wheel is rotated to drive the belt. The light source is adapted to illuminate the pattern on the belt. The image sensor is adapted to capture an image of the pattern as a result of the illumination. The processing unit is coupled to the image sensor and is adapted to recognize a feature change of the image of the pattern to obtain the rotation direction and rotation speed of the first wheel.

The present invention further provides a mouse wheel assembly. The mouse wheel assembly includes a wheel, a light source, an image sensor and a processing unit. The wheel has a pattern formed thereon. The light source is adapted to illuminate the pattern on the wheel. The image sensor is adapted to capture an image of the pattern as a result of the illumination. The processing unit is coupled to the image sensor and is adapted to recognize a feature change of the image of the pattern to obtain the rotation direction and rotation speed of the wheel.

The present invention further provides a mouse wheel assembly. The mouse wheel assembly includes a first wheel, a second wheel, a belt, a light source, an image sensor and a processing unit. The belt has a transparent pattern formed thereon. The belt is looped over the first wheel and the wheel surface of the second wheel, wherein the second wheel is driven to rotate by the belt when the first wheel is rotated to drive the belt. The light source is adapted to illuminate the pattern on the belt. The image sensor is positioned opposite to the light source across the belt and is adapted to capture an image of the pattern as a result of the illumination. The processing unit is coupled to the image sensor and is adapted to recognize a feature change of the image of the pattern to obtain the rotation direction and rotation speed of the first wheel.

The present invention further provides a mouse wheel assembly. The mouse wheel assembly includes a belt and an optical module. The belt has a pattern formed thereon. The optical module is adapted to illuminate the pattern on the belt, capture an image of the pattern as a result of the illumination and recognize a feature change of the image of the pattern to obtain the movement direction and movement speed of the belt.

The present invention further provides a mouse wheel assembly. The mouse wheel assembly includes a wheel and an optical module. The wheel has a pattern formed thereon. The optical module is adapted to illuminate the pattern on the wheel, capture an image of the pattern as a result of the illumination and recognize a feature change of the image of the pattern to obtain the rotation direction and rotation speed of the wheel.

According to the present invention, the mouse wheel assembly uses an image sensor to capture the feature changes, such as the changes of a pattern on a member, such as a belt or a wheel thereby obtaining the operation direction and rotation speed of a wheel. Furthermore, the resolution of the mouse wheel assembly can be adjusted by changing the dimension of the pattern. There is no need to use expensive encoders of high resolution in order to enhance the resolution. Therefore, the production cost of the mouse wheel assembly of the present invention can be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of a conventional mouse apparatus.

FIG. 2 is a schematic diagram of a conventional mechanical mouse wheel structure.

FIG. 3 is a cross-sectional view of the mouse apparatus and mouse wheel assembly according to the first embodiment of the present invention.

FIG. 3a is a schematic diagram of a feature on the belt of FIG. 3.

FIG. 4 is a cross-sectional view of the mouse apparatus and mouse wheel assembly according to the second embodiment of the present invention.

FIG. 5 is a cross-sectional view of the mouse apparatus and mouse wheel assembly according to the third embodiment of the present invention.

FIG. 6 is a cross-sectional view of the mouse apparatus and mouse wheel assembly according to the fourth embodiment of the present invention.

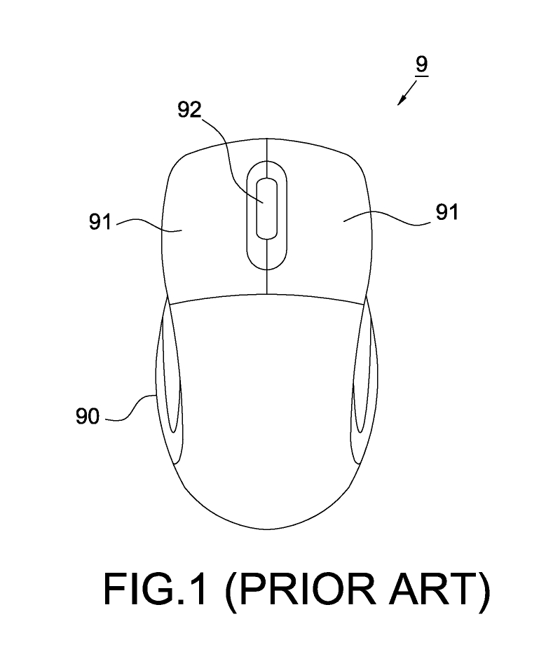

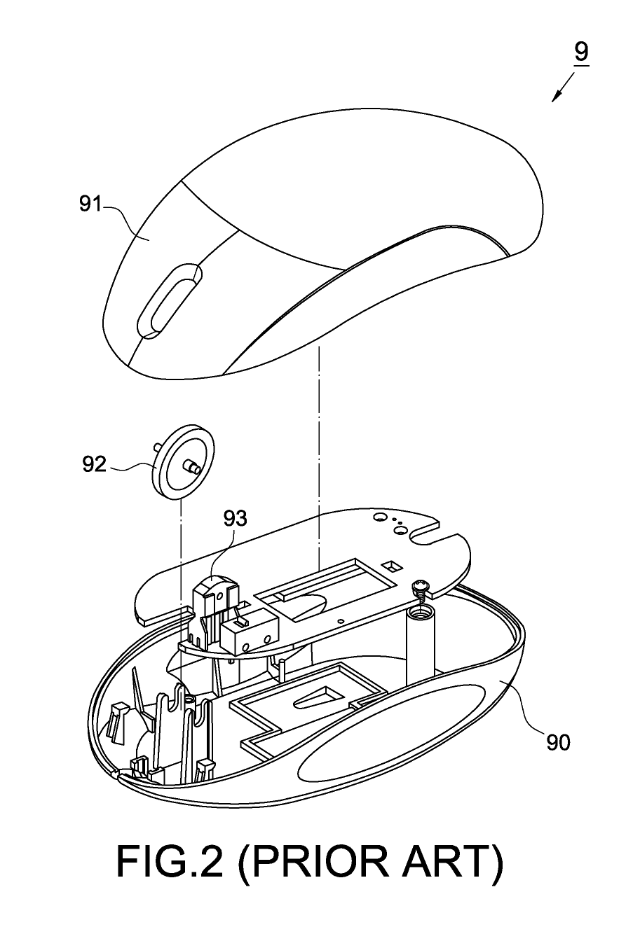

### DETAILED DESCRIPTION OF THE PREFERRED EMBODIMENT

The foregoing, as well as additional objects, features and advantages of the invention will be more readily apparent from the following detailed description, which proceeds with reference to the accompanying drawings. In this invention, identical reference numerals will be used when designating substantially identical elements that are common to the figures.

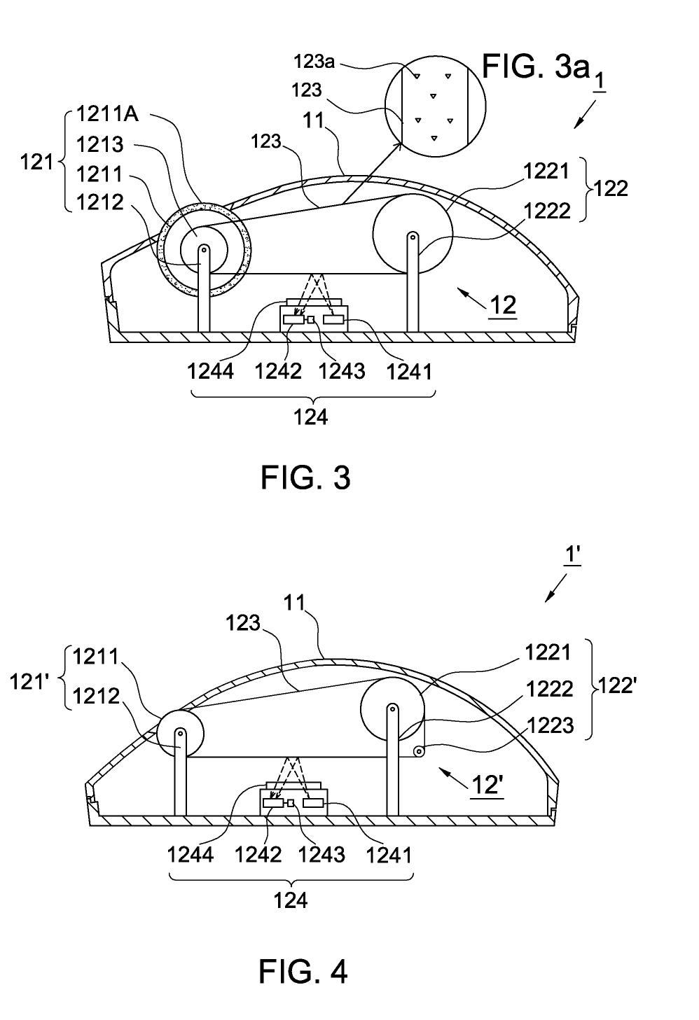

Referring to FIG. 3, the mouse apparatus 1 according to the first embodiment of the present invention includes a housing 11 and a mouse wheel assembly 12 positioned in the housing 11. A user can operate the mouse apparatus 1 to, for example, control the refreshing of the content of the display. Furthermore, the mouse wheel assembly 12 can be used to, for example, scroll, zoom in or zoom out the screen. It is to be noted that the functions of the mouse apparatus 1 and mouse wheel assembly 12 are not limited to the foregoing description.

The mouse wheel assembly 12 includes a first wheel set 121, a second wheel set 122, a belt 123 and an optical module 124. The first wheel set 121 includes a first wheel 1211, a first supporting member 1212 and an inner wheel 1213 securely mounted on a side surface of the first wheel 1211. The first wheel 1211 and inner wheel 1213 are concentric and pivotally connected to the first supporting member 1212. Thus, the inner wheel 1213 will synchronously rotate with the first wheel 1211 when the first wheel 1211 rotates about the pivot. The first wheel 1211 has a wheel surface 1211A, a portion of which is exposed from the housing 11 such that a user can rotate the first wheel 1211 therethrough. The second wheel set 122 includes a second supporting member 1222 and a second wheel 1221 pivotally connected to the second supporting member 1222. The belt 123 is a looped strip of flexible material and is looped over the wheel surface of the inner wheel 1213 and the wheel surface of the second wheel 1221. In this way the inner wheel 1213 will drive the second wheel 1221 to rotate through the belt 123 when a user rotates the first wheel 1211 through the exposed portion of the wheel surface 1211A. In the meantime, at least one portion of the belt 123 will transversely move with respect to the optical module 124. Referring to FIG. 3a, a feature, such as a pattern 123a recognizable for the optical module 124 is formed on a surface of the belt 123 that will be not in contact with the wheel surface of the inner wheel 1213 when the belt 123 is driven to move. It should be appreciated that the pattern 123a of FIG. 3a is only illustrative and not limited to the scope of the invention. Any features recognizable for the optical module 124 can be used as the pattern 123a.

The optical module 124 is located in a position where the image of the pattern 123a can be clearly captured. For example, the optical module 124 is positioned to face the belt 123. The optical module 124 includes a light source 1241, an image sensor 1242, a processing unit 1243 and a lens (or a lens set) 1244. In this embodiment, the light source 1241 is configured to illuminate the pattern 123a on the belt 123 and can be an LED (light emitting diode) or a laser diode. The image sensor 1242 is configured to capture an image of the pattern 123a on the belt 123 as a result of the illumination. The image sensor 1242 can be, but not limited to, a CCD image sensor or a CMOS image sensor. The processing unit 1243 is coupled to the image sensor 1242 and is configured to recognize the image of the pattern 123a captured by the image sensor 1242. Since the pattern 123a moves with the belt 123, the image of the pattern 123a captured by the image sensor 1242 will change over time when the belt 123 is driven to move. Accordingly, the movement direction and movement speed of the belt 123 with respect to the image sensor 1242 can be obtained by that the processing unit 1243 recognizes the feature change of the image of the pattern 123a captured by the image sensor 1242. The lens 1244 is configured to guide the light beams emitting from the light source 1241 to the pattern 123a on the belt 123 and then guide the light beams reflected by the pattern 123a to the image sensor 1242. In this embodiment, the lens 1244 is not necessary for implementing the present invention.

According to the mouse apparatus of the present invention, a user can rotate the first wheel 1211 to drive the belt 123 and second wheel 1221 to rotate. The processing unit 1243 can recognize the feature change of the image of the pattern 123a to obtain the rotation direction and rotation speed of the first wheel 1211. In addition, in order to clearly capture the feature change of the image of the pattern 123a, at least one portion of the surface of the belt 123 is parallel to the sensing surface of the image sensor 1242. The image sensor 1242 is apart from the belt 123 an appropriate distance, for example, the distance equal to the focal length of the image sensor 1242.

In one embodiment, the light source 1241 is separately arranged outside the optical module 124. In another embodiment, the lens 1244 can be integrally formed on the optical module 124. In addition, the first wheel set 121, second wheel set 122, belt 123 and optical module 124 together form an optical mouse wheel module thereby facilitating the mouse wheel assembly 12 to be installed in various mouse apparatus. In this manner the practicability of the mouse wheel assembly 12 of the present invention can be increased.

In another embodiment, the first wheel set 121 does not include the inner wheel 1213. The belt 123 is looped over the wheel surface 1211A of the first wheel 1211 and the wheel surface of the second wheel 1221. In this manner a user can rotate the first wheel 1211 through the exposed portion of the wheel surface 1211A to synchronously drive the first wheel 1211 and second wheel 1221 to rotate. The image sensor 1242 will capture the feature change of the pattern 123a. The processing unit 1243 then analyzes the feature change of the image of the pattern 123a to obtain the rotation direction and rotation speed of the first wheel 1211.

Referring to FIG. 4, the mouse apparatus 1′ according to the second embodiment of the present invention also includes a mouse wheel assembly 12′ positioned in the housing 11. The mouse wheel assembly 12′ includes a first wheel set 121′, a second wheel set 122′, the belt 123 and the optical module 124. Since the belt 123 and optical module 124 of FIG. 4 are the same as the corresponding elements described in FIG. 3, any further illustrations of those elements are omitted herein. The differences between this and the first embodiment will be described as follows. The first wheel set 121′ includes only the first wheel 1211 and first supporting member 1212, but not the inner wheel 1213. Therefore, the belt 123 is directly looped over the wheel surface 1211A of the first wheel 1211. The second wheel set 122′ includes the second wheel 1221, second supporting member 1222 and a positioning member 1223. The positioning member 1223 is configured to position the belt 123 such that at least one portion of the surface of the belt 123 is parallel to the sensing surface of the optical module 124. In addition, the positioning member 1223 is also configured to adjust the distance between the belt 123 and image sensor 1242. In this way the image sensor 1242 of the optical module 124 can clearly capture the feature change of the image of the pattern 123a on the belt 123. Similarly, in this embodiment, the first wheel set 121′, second wheel set 122′, belt 123 and optical module 124 together can also form an optical mouse wheel module thereby facilitating the mouse wheel assembly 12′ to be installed in various mouse apparatus. In addition to the above-mentioned elements, the other elements not described in detail above in this embodiment are the same as the corresponding elements of FIG. 3. Thus, any further illustrations of those elements are omitted herein.

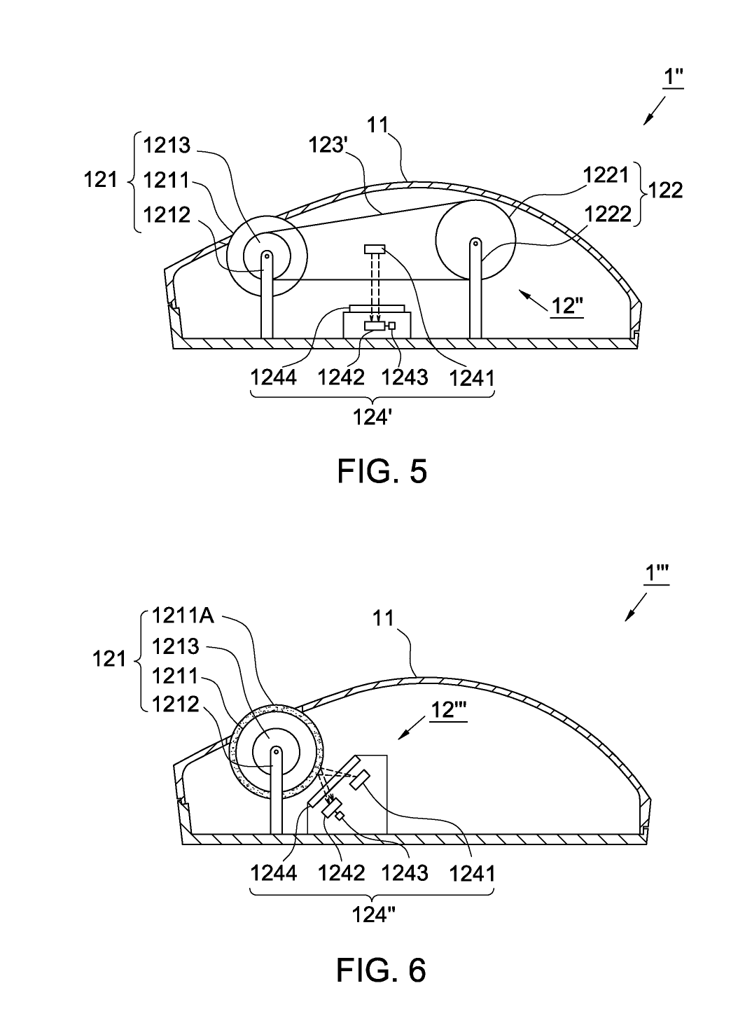

Referring to FIG. 5, the mouse apparatus 1″ according to the third embodiment of the present invention includes a mouse wheel assembly 12″ positioned in the housing 11. The mouse wheel assembly 12″ includes the first wheel set 121 (or 121′), the second wheel set 122 (or 122′), a belt 123′ and an optical module 124′. Since the first wheel set 121/121′, second wheel set 122/122′ of FIG. 5 are the same as the corresponding elements described in FIG. 4 or 5, any further illustrations of those elements are omitted herein. The differences between this and the first or second embodiment will be described as follows. The light source 1241 and image sensor 1242 are positioned at opposite sides of at least one portion of the belt 123′, respectively. In addition, partially transparent features are formed on the belt 123′. For example, transparent or opaque patterns are formed on the belt 123′. When the patterns are transparent, the other portions of the belt 123′ are opaque in comparison with the transparent patterns. However, when the patterns are opaque, the other portions of the belt 123′ are transparent in comparison with the opaque patterns. In this way a bright-and-dark image will be cast on and captured by the image sensor 1242 when the light source 1241 illuminates the belt 123′. The processing unit 1243 then analyzes the feature change of the image of the pattern captured by the image sensor 1242 to obtain the movement direction and movement speed of the belt 123′. Similarly, in this embodiment, the first wheel set 121/121′, second wheel set 122/122′, belt 123′ and optical module 124′ together can also form an optical mouse wheel module thereby facilitating the mouse wheel assembly 12″ to be installed in various mouse apparatus.

Referring to FIG. 6, the mouse apparatus 1′″ according to the fourth embodiment of the present invention includes a mouse wheel assembly 12′″ positioned in the housing 11. The mouse wheel assembly 12′″ includes a first wheel set 121 and an optical module 124″. The first wheel set 121 includes a first wheel 1211 and a first supporting member 1212. The first wheel 1211 has a wheel surface 1211A and a pattern is formed on the wheel surface 1211A. The optical module 124″ includes a light source 1241, an image sensor 1242, a processing unit 1243 and a lens 1244. The light source 1241 is configured to illuminate the wheel surface 1211A of the first wheel 1211. The image sensor 1242 is configured to capture an image of the pattern on the wheel surface 1211A as a result of the illumination. The processing unit 1243 is coupled to the image sensor 1242 and is configured to recognize the image of the pattern captured by the image sensor 1242. Since the pattern will rotate with the first wheel 1211, the image of the pattern captured by the image sensor 1242 will change over time when the first wheel 1211 is rotated. Accordingly, the rotation direction and rotation speed of the first wheel 1211 can be obtained by that the processing unit 1243 recognizes the feature change of the image of the pattern captured by the image sensor 1242. In one embodiment, the lens 1244 can be integrally formed on the optical module 124. In this embodiment, the first wheel set 121 and optical module 124″ together form an optical mouse wheel module thereby facilitating the mouse wheel assembly 12′″ to be installed in various mouse apparatus.

In another embodiment, the first wheel set 121 can further include an inner wheel 1213 securely mounted on a side surface of the first wheel 1211. The inner wheel 1213 will synchronously rotate with the first wheel 1211 when the first wheel 1211 rotates about the pivot. The pattern is formed on the wheel surface of the inner wheel 1213. The optical module 124 is used to capture an image of the pattern on the wheel surface of the inner wheel 1213 and then the processing unit 1243 analyzes the feature change of the image of the pattern to obtain the rotation direction and rotation speed of the first wheel 1211.

According to the present invention, the resolution of the mouse wheel assembly of the mouse apparatus depends on the dimension of the pattern.

In should be appreciated that the dimensions and arrangements of the elements shown in FIGS. 3 to 6 is only illustrative and not limited to the scope of the invention.

As described above, the conventional mechanical mouse apparatus uses mechanical encoders and the mechanical encoders are usually of poor resolution. The resolution of the mechanical mouse apparatus can only be enhanced by replacing the mechanical encoder with one that is of high resolution. However, a high-resolution mechanical encoder is always expensive. In order to solve the above problems, the present invention provides an optical mouse wheel assembly that is of high resolution and low cost. The optical mouse wheel assembly of the present invention uses an image sensor to capture the feature change of the image of a pattern so as to obtain the rotation direction and rotation speed of the wheel, wherein the pattern is formed on a belt, a wheel or other elements.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A mouse wheel assembly, comprising:
a belt having a transparent pattern formed thereon;
a light source adapted to illuminate the transparent pattern on the belt;
an image sensor positioned opposite to the light source across the belt, the image sensor being adapted to capture images of the transparent pattern as a result of the illumination; and
a processing unit coupled to the image sensor, the processing unit being adapted to recognize a feature change of the images of the transparent pattern to obtain a movement direction and a movement speed of the belt.

2. The mouse wheel assembly as claimed in claim 2, further comprising:
a lens adapted to direct light beams emitting from the light source.

3. The mouse wheel assembly as claimed in claim 1, further comprising:
a first supporting member;
a second supporting member;
a first wheel pivotally connected to the first supporting member; and
a second wheel pivotally connected to the second supporting member,
wherein the belt is looped over the first wheel and a wheel surface of the second wheel, and the second wheel is driven to rotate by the belt when the first wheel is rotated to drive the belt.

4. The mouse wheel assembly as claimed in claim 3, wherein the processing unit is further adapted to obtain a rotation direction and a rotation speed of the first wheel according to the feature change of the images of the transparent pattern.

5. The mouse wheel assembly as claimed in claim 3, wherein the first wheel comprises an inner wheel mounted on a side surface thereof, the belt is looped over a wheel surface of the inner wheel and the wheel surface of the second wheel.

6. The mouse wheel assembly as claimed in claim 3, wherein the first supporting member, the first wheel, the second supporting member, the second wheel, the belt, the light source, the image sensor and the processing are formed as a module.

7. The mouse wheel assembly as claimed in claim 1, wherein the mouse wheel assembly has a resolution that depends on a dimension of the transparent pattern.

8. The mouse wheel assembly as claimed in claim 1, wherein the transparent pattern has partially transparent features.

9. The mouse wheel assembly as claimed in claim 1, wherein the partially transparent features are formed by transparent patterns and an opaque belt.

10. The mouse wheel assembly as claimed in claim 1, wherein the partially transparent features are formed by opaque patterns and a transparent belt.
